(19) United States
(12) Patent Application Publication
(10) Pub. No.: US 2007/0081248 A1
(43) Pub. Date: Apr. 12, 2007

(54) Reflector

(76) Inventor: Kuohua Wu, Tucson, AZ (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/247,539

(22) Filed: Oct. 11, 2005

(51) Int. Cl. G02B 1/10

(52) U.S. Cl. 359/586; 359/584

(57) ABSTRACT

A reflector includes a substrate having a first end and a second end and an optical coating of at least first and second materials having differing refractive indices deposited on the substrate. The optical coating includes a plurality of alternating layers of the first and second materials with each layer having a thickness which increases from the first end to the second end of the substrate.

### BACKGROUND

Digital light processing (DLP) projectors generally may include a light source, a controller, and some type of spatial light modulator (SLM), such as a digital micro-mirror device (DMD), to control projection of light from the light source onto a screen or other surface so as to form a desired image. A DMD may include an array of hundreds or thousands of tiny mirrors which can be individually tilted, wherein each mirror provides light for one pixel of the image. In operation, the controller receives image data representative of an image which is desired to be projected. For each image, the controller tilts selective mirrors back and forth (i.e. modulates) to intermittently direct light to the screen and create a desired brightness level based on the image data of the corresponding pixel.

The light source may include a lamp which generates light and a reflector which directs the light from the lamp to the DMD. The reflector may be parabolic or semi-elliptical in shape with a “closed” end positioned proximate to the lamp and an “open” end away from the lamp where the reflected light is directed to the DMD. The lamp may produce electromagnetic radiation in the ultraviolet (UV) portion (wavelengths between 10 nm-400 nm), the visible portion (wavelengths between 400 nm-750 nm), and the infrared (IR) portion (wavelengths between 750 nm-20,000 nm) of the electromagnetic spectrum. While light from the visible portion is highly desirable to enhance the color and brightness of projected images, projector components, such as lenses, may be damaged by UV and IR radiation.

As such, reflectors have been developed which attempt to provide a reflective bandwidth having a reflectance as high as possible in the visible region and a reflectance as low as possible in the UV and IR regions. Such reflectors may include an optical coating consisting of layer of high and low refracting materials applied alternately to a substrate material, such as glass, for example.

Some such reflectors have a reflective bandwidth roughly equal to the visible portion of the electromagnetic spectrum for electromagnetic radiation at low incident angles (e.g. 20 degrees or less), but have a reflective bandwidth that decreases as the angle of incidence of the electromagnetic radiation increases. In some instances, the reflective bandwidth at an incident angle of 50 degrees may extend only between 400 nm and 650 nm. As such, the colors are not equally reflected (with the lower visible wavelengths being reflected more than the higher visible wavelengths), resulting in a reduction in the red color range and the brightness of the projected image. Other such reflectors may have a reflective bandwidth roughly equal to the visible portion of the electromagnetic spectrum over a broader range of incident angles of electromagnetic radiation, but do so at the expense of reflecting potentially damaging IR radiation.

### SUMMARY

One form of the present invention provides a reflector including a substrate having a first end and a second end and an optical coating of at least first and second materials having differing refractive indices deposited on the substrate. The optical coating includes a plurality of alternating layers of the first and second materials with each layer having a thickness which increases from the first end to the second end of the substrate.

### BRIEF DESCRIPTION OF THE DRAWINGS

FIG. 1 is a block diagram illustrating one embodiment a projector employing a reflector according to embodiments of the present invention.

FIG. 2A is a cross-sectional view of a portion of the reflector of FIG. 1 according to one embodiment of the present invention.

FIG. 2B is a cross-sectional view of a portion of a reflector according to one embodiment of the present invention.

FIG. 3 is a graph illustrating the reflectance performance of the reflector of FIG. 2A according to one embodiment of the present invention.

FIG. 4 is a graph illustrating the reflectance performance of a reflector constructed according to one conventional technique.

FIG. 5 is a graph illustrating the reflectance performance of a reflector constructed according to another conventional technique.

### DETAILED DESCRIPTION

In the following detailed description of the preferred embodiments, reference is made to the accompanying drawings, which form a part hereof, and in which is shown by way of illustration specific embodiments in which the invention may be practiced. It is to be understood that other embodiments may be utilized and structural or logical changes may be made without departing from the scope of the present invention. The following detailed description, therefore, is not to be taken in a limiting sense, and the scope of the present invention is defined by the appended claims.

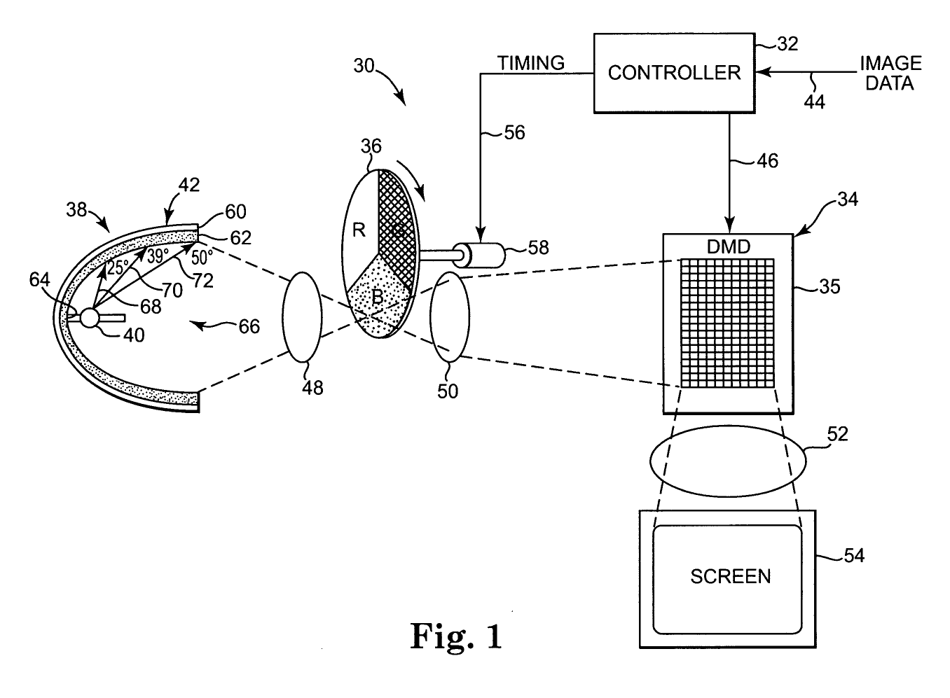

FIG. 1 illustrates one embodiment of a digital light processing (DLP) projector 30 utilizing a reflector employing a wedge-type optical coating in accordance with embodiments of the present invention to provide over a desired range of incident angles of electromagnetic radiation a reflective bandwidth approximately equal to the visible portion of electromagnetic spectrum. In one embodiment, projector 30 includes a controller 32, a spatial light modulator 34, such as a digital micro-mirror device (DMD) 35, a rotating color wheel 36, and a light source 38, with light source 38 further including a lamp 40 and a reflector 42 in accordance with the present invention. Projector 30, as illustrated by FIG. 1, may be referred to as a sequential color projector. The embodiments described herein, however, are also applicable to non-sequential color projectors.

In one embodiment, controller 32 receives an image signal 44 representative of frames of a desired image to be projected and which may be in the form of an analog video signal or graphics data already in digital form. Controller 32 performs various processes to prepare image signal 44 for display such as, for example, a linearization operation to remove the effect of gamma conversion and a color-space conversion to convert/separate the image data into appropriate color components. For example, in one embodiment, projector 30 comprises an RGB-type (red, blue, green) projector, wherein controller 32 converts the image data to appropriate RGB data values.

In one embodiment, controller 32 assembles the processed data into a “bit plane” format, with one bit plane for each color component of each frame of image data. The assembled bit planes are delivered via a data path 46 to DMD 35, which sequentially displays the bit planes of each color component for each image frame. The bit plane format provides one bit at a time to each pixel (i.e. mirror element) of DMD 35, which turns each pixel on-and-off (i.e. modulates an angle of the mirror element) based on a “weight” of the corresponding bit. For example, where each pixel is represented by n-bits for each of the three colors, controller 32 provides three n-bit planes per image frame with bit planes containing less significant bits resulting in shorter display times than bit planes containing more significant bits.

In one embodiment, light from lamp 40 is directed by reflector 42 to DMD 35 via color wheel 36 and one or more lenses 48, 50. In one embodiment, lens 48 focuses light received from reflector 42 onto color wheel 36. In the illustrative example, color wheel 36 includes three color segments or filters (i.e. red (R), blue (B) and green (G)). In other embodiments, projector 30, and thus color wheel 36, could employ other colors and fewer or more than three colors. In one embodiment, after passing through color wheel 36, lens 50 directs the filtered light to the micro-mirror array of DMD 35 for subsequent projection via a projection lens 52 onto a desired surface, such as screen 54. In some embodiments, architectures other than a color wheel are employed to generate color components.

In one embodiment, as DMD 35 sequentially displays the bit plane data of each component color of each image frame, controller 32 provides timing signals via a path 56 to control a motor 58 to synchronize the rotation of color wheel 36 so that light is transmitted through a color segment corresponding to the color of the bit plane data being displayed. For each pixel, the combination of the sequential modulation of the three component colors is perceived as the desired color on screen 54. To maintain proper synchronization between the color segment of color wheel 36 through which light is passing and the color of the bit plane data being displayed by DMD 35, controller 32 can speed up or slow down the rotation of color wheel 36 or data can be delayed or skipped.

Lamp 40 may comprise one of any number of standard lamps such as, for example, a tungsten-halogen lamp, a xenon lamp, a mercury arc lamp, or any other light generating source. Such lamps typically produce electromagnetic radiation in the UV portion (i.e. wavelengths between 10 nm -400 nm), the visible portion (i.e. wavelengths between 450 nm-750 nm), and the IR portion (i.e. wavelengths between 750 nm-20,000 nm) of the electromagnetic spectrum. While radiation from the visible portion is desirable to enhance the color and brightness of the projected image on screen 54, the UV and IR radiation can damage projector components such as DMD 35, color wheel 36, and lenses 48, 50, and 52.

In one embodiment, reflector 42 includes a substrate 60 on which an optical coating 62 is deposited. In one embodiment, as illustrated in FIG. 1, reflector 42 is generally semi-elliptical in shape with a “closed” first end 64 positioned proximate to lamp 40 and an “open” second end 66 from which radiation produced by lamp 40 and reflected by optical coating 62 is directed toward lens 48. Due to the semi-elliptical shape of reflector 42, the incident angle of radiation upon optical coating 62 from lamp 40 increases over a range of incident angles from approximately the first end 64 to the second end 66 of reflector 42, as indicated by arrows 68, 70, and 72. The term “incident angle” as employed herein refers to the deviation of the incident radiation from a reference line normal (perpendicular) to the reflector's surface.

According to one embodiment of the present invention, as will be described in greater detail below, optical coating 62 comprises a plurality of alternating layers of a high refractive material and a low refractive material, wherein each of the alternating layers increases in thickness from generally the first end 64 to the second end 66 of reflector 42 such that a reflective bandwidth for electromagnetic radiation incident upon optical coating 62 at each incident angle within a range of incident angles from generally the first end 64 to second end 66 is substantially equal to the visible portion of the electromagnetic spectrum. In one exemplary embodiment, optical coating 62 comprises alternating layers of titanium dioxide (TiO₂) and silicon dioxide (SiO₂), as described below.

In one embodiment, the thickness of each of the alternating layers of optical coating 62 increases from generally the first end 64 to the second end 66 of reflector 42 based on the angle of incidence of the electromagnetic radiation. In one embodiment, the thickness of each of the alternating layers of optical coating 62 increases from a point along substrate 60 where the angle of incident radiation is approximately zero-degrees to the second end 66. In one exemplary embodiment, the thickness of each of the alternating layers of optical coating 62 increases from a point along substrate 60 where the angle of incident radiation is approximately 10-degrees to the second end 66. In one embodiment, the angle of incidence of electromagnetic radiation at second end 66 is approximately 50-degrees. It is noted that the angle of incidence, as is commonly understood, is the angle of deviation from a line perpendicular to reflector 42.

In one embodiment, the thickness of each of the alternating layers increases linearly from generally the first end 64 to the second end 66 of reflector 42. In one exemplary embodiment, the thickness of each of the alternating layers increases linearly such that each of the alternating layers is approximately 15 percent thicker at the second end 66 than at the first end 64. In one exemplary embodiment, each of the alternating layers is thicker at second end 66 than at first end 64 by a percentage that is within a range of percentages from approximately 10 percent to approximately 20 percent. In other embodiments, the thickness of each of the alternating layers increases non-linearly from the first end 64 to the second end 66, with optical coating 62 being thicker at second end 66 than at first end 64.

As a result of gradually increasing the thickness of each of the alternating layers from generally the closed end to the open end of reflector 42, optical coating 62 has a wedge-like cross-section, with a thick end of the wedge at second end 66 and a thin end of the wedge at first end 64. By employing a wedge-like optical coating in accordance with the present invention, reflector 42 provides a reflective bandwidth for electromagnetic radiation at each incident angle within a range of incident angles upon reflector 42 that is substantially equal to the visible portion of the electromagnetic spectrum. As such, unlike conventional reflectors, reflector 42 improves brightness and equalizes the color of an image projected by projector 30 without transmitting potentially damaging UV and IR radiation to projector components.

Additionally, gradually increasing the thickness of the layers of optical coating 62 in accordance with the present invention requires fewer layers and less volume of dielectric materials than employed by conventional reflectors to improve brightness and equalize color reflectance. As such, wedge-coating techniques in accordance with the present invention are less costly to implement and less susceptible to cracking or deterioration due to thermal expansion and contraction cycles of the reflector.

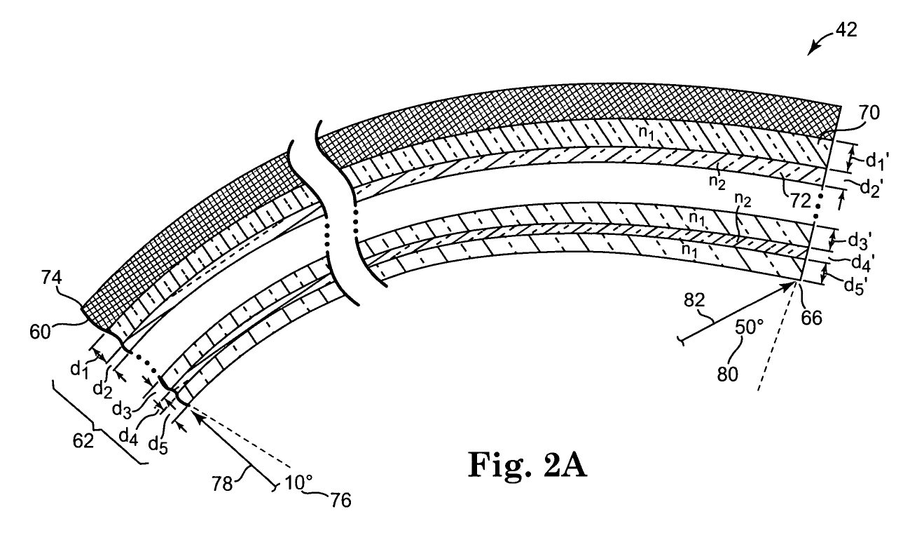

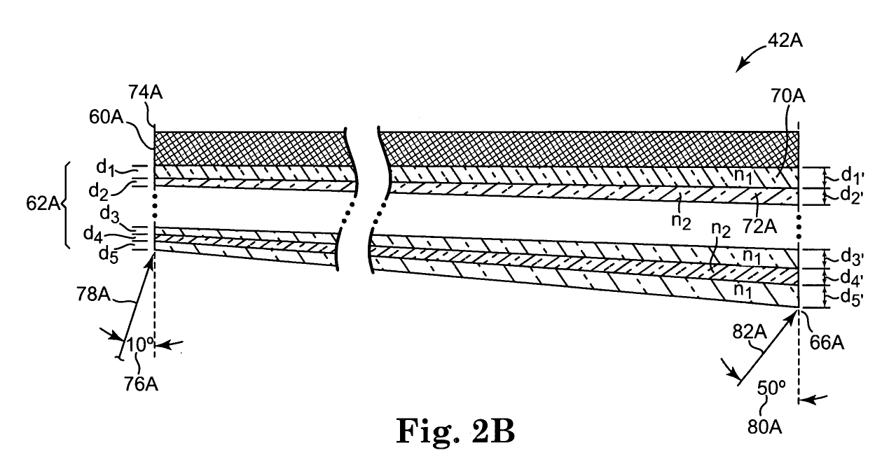

FIG. 2A is a longitudinal cross-section through a portion of reflector 42 of FIG. 1 illustrating one embodiment of optical coating 62 in accordance with the present invention. In one embodiment, optical coating 62 includes a plurality of alternating layers of a first material 70 having a refractive index n₁ and a second material 72 having a refractive index n₂ deposited on substrate 60. In one exemplary embodiment, substrate 60 comprises borosilicate glass, often referred to as BK-7 glass. In one embodiment, refractive index n₁ of first material 70 is greater than refractive index n₂ of second material 72. In one exemplary embodiment, first material 70 comprises TiO₂ having a refractive index n₁ of approximately 2.38 and second material 72 comprises SiO₂ having a refractive index n₂ of approximately 1.46.

In one embodiment, as illustrated in FIG. 2A, the thickness of each of the alternating layers increases linearly from a point 74 along reflector 42 where an angle of incidence 76 of radiation 78 is approximately 10-degrees to the second end 66 of reflector 42. In one embodiment, as illustrated in FIG. 2A, an angle of incidence 80 between radiation 82 and the second end 66 of reflector 42 is approximately 50-degrees. In one exemplary embodiment, the thickness of each layer increases linearly from point 74 to second end 66 such that the thickness of each layer is approximately 15 percent greater at second end 66 than at point 74. As such, dimensions d₁′, d₂′, d₃′, d₄′, and d₅′ of each layer at second end 66 are each approximately 15 percent greater than their corresponding dimension d₁, d₂, d₃, d₄, and d₅ at point 74. In one embodiment, each layer of first material 70 has a same thickness (e.g. d₁=d₃=d₅, and d₁′=d₃′=d₅′) and each layer of second material 72 has a same thickness (e.g. d₂=d₄, and d₂′=d₄′). In other embodiments, however, the thicknesses of each layer of first material 70 and the thicknesses of each layer of second material 72 need not be equal.

Optical coating 62 can be formed on substrate 60 using conventional thin-film deposition techniques commonly known to those skilled in the art. For example, in one embodiment, sputtering deposition processes can be employed to form the alternating layers of optical coating 62 on substrate 60. Sputtering generally involves knocking atoms from a “target” by bombarding the target with ions from a plasma (usually a noble gas, such as Argon). Typically, a small amount of a non-noble gas, such as oxygen, is mixed with the plasma forming gas. Atoms “sputtered” from the target react with the gas mixture to form an oxide of the target material which is subsequently deposited on a desired surface (i.e. substrate 60) to form optical coating 62. The wedge-like profile of the layers of optical coating 62 can be achieved by adjusting various factors associated with the sputtering process such as, for example, the distance between the target and substrate 60, the amount of oxygen in the plasma, the amount of the ion source, and the power provided to the target material.

In another embodiment, evaporation deposition techniques can be employed to form the alternating layers of optical coating 62 on substrate 60. Evaporation deposition generally involves evaporating a metal source with an ion beam which is steered into the metal source using a magnetic field. The evaporated metal is then deposited on a desired surface, such as substrate 60. The wedge-like profile of the layers of optical coating 62 can be achieved by adjusting various factors associated with the evaporation process such as rotation of reflector 42 relative to the metal source, masking of the metal source and/or reflector 42, and control of the ion beam, gas flow, and evaporation rate.

In another embodiment, chemical vapor deposition (CVD) techniques can employed to form the alternating layers of optical coating 62 on substrate 60. CVD generally involves heating a substrate, such as substrate 60, and transporting high vapor pressure gaseous compounds of materials to be deposited to the substrate surface. The gaseous compounds react and/or decompose on the substrate surface to produce the desired deposit.

In one exemplary embodiment of reflector 42, as outlined in Table I below, optical coating 62 comprises 13 layers of TiO₂ alternating with 12 layers of SiO₂ beginning with a first layer of TiO₂ deposited on substrate 60 comprising BK-7 glass. Table I details the type of material, the refractive index, and thickness of each layer with layer “1” being the top layer and layer “25” being the bottom layer in contact with the BK-7 substrate material.

TABLE I

| | | REFRACTIVE | THICKNESS |
|---|---|---|---|
| LAYER | MATERIAL | INDEX (n) | (nm) |
| 1 | TiO₂ | 2.38 | 56.01 |
| 2 | SiO₂ | 1.46 | 81.75 |
| 3 | TiO₂ | 2.38 | 54.98 |
| 4 | SiO₂ | 1.46 | 81.99 |
| 5 | TiO₂ | 2.38 | 50.43 |
| 6 | SiO₂ | 1.46 | 81.99 |
| 7 | TiO₂ | 2.38 | 50.43 |
| 8 | SiO₂ | 1.46 | 81.99 |
| 9 | TiO₂ | 2.38 | 50.43 |
| 10 | SiO₂ | 1.46 | 81.99 |
| 11 | TiO₂ | 2.38 | 50.43 |
| 12 | SiO₂ | 1.46 | 98.39 |
| 13 | TiO₂ | 2.38 | 70.6 |
| 14 | SiO₂ | 1.46 | 114.79 |
| 15 | TiO₂ | 2.38 | 70.6 |
| 16 | SiO₂ | 1.46 | 114.79 |
| 17 | TiO₂ | 2.38 | 70.6 |
| 18 | SiO₂ | 1.46 | 114.79 |
| 19 | TiO₂ | 2.38 | 70.6 |
| 20 | SiO₂ | 1.46 | 114.79 |
| 21 | TiO₂ | 2.38 | 70.6 |
| 22 | SiO₂ | 1.46 | 114.79 |
| 23 | TiO₂ | 2.38 | 53.17 |
| 24 | SiO₂ | 1.46 | 136.56 |
| 25 | TiO₂ | 2.38 | 22.19 |
| SUBSTRATE | BK-7 | 1.52 | |

In Table I, the thickness of each layer indicates the thickness at point 74 (i.e. angle of incidence of approximately 10-dgrees). Although not indicated in Table I, each of the alternating layers of TiO₂ and SiO₂ in the exemplary embodiment linearly increases in thickness by approximately 15 percent from point 74 to second end 66.

Although described primarily as being applied to a curved substrate, optical coatings according to the present invention can also be applied to a flat substrate. FIG. 2B is longitudinal cross-section through a portion of a reflector 42A employing an optical coating 62A in accordance with the present invention. Reflector 42A is similar to reflector 42 of FIG. 2A except that substrate 60A is substantially flat.

In one embodiment, optical coating 62A includes a plurality of alternating layers of a first material 70A having a refractive index n₁ and a second material 72A having a refractive index n₂ deposited on substrate 60A. In one exemplary embodiment, substrate 60A comprises borosilicate glass, often referred to as BK-7 glass. In one embodiment, refractive index n₁ of first material 70A is greater than refractive index n₂ of second material 72A. In one exemplary embodiment, first material 70A comprises TiO₂ having a refractive index n₁ of approximately 2.38 and second material 72A comprises SiO₂ having a refractive index n₂ of approximately 1.46.

In one embodiment, as illustrated in FIG. 2B, the thickness of each of the alternating layers increases linearly from a point 74A along reflector 42A where an angle of incidence 76A of radiation 78A is approximately 10-degrees to the second end 66A of reflector 42A. In one embodiment, as illustrated in FIG. 2B, an angle of incidence 80A between radiation 82A and the second end 66A of reflector 42A is approximately 50-degrees. In one exemplary embodiment, the thickness of each layer increases linearly from point 74A to second end 66A such that the thickness of each layer is approximately 15 percent greater at second end 66A than at point 74A. As such, dimensions d₁′, d₂′, d₃′, d₄′, and d₅′ of each layer at second end 66A are each approximately 15 percent greater than their corresponding dimension d₁, d₂, d₃, d₄, and d₅ at point 74A. In one embodiment, each layer of first material 70A has a same thickness (e.g. d₁=d₃=d₅, and d₁′=d₃′=d₅′) and each layer of second material 72A has a same thickness (e.g. d₂=d₄, and d₂′=d₄′). In other embodiments, however, the thicknesses of each layer of first material 70A and the thicknesses of each layer of second material 72A need not be equal.

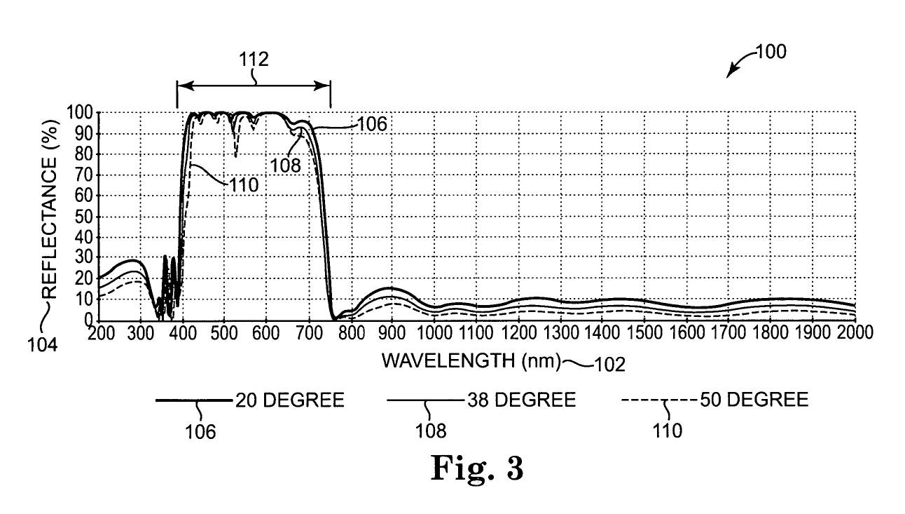

FIG. 3 is a graph 100 illustrating the reflective performance of the exemplary embodiment of reflector 42 as described with reference to FIG. 2A and Table I. The wavelength of incident radiation from a light source, such as lamp 40, is illustrated along the x-axis, as indicated at 102, and the reflectance of reflector 42 (in percent) is illustrated along the y-axis, as indicated at 104. A first curve 106 illustrates the reflectance of radiation at an incident angle of approximately 20 degrees, a second curve 108 illustrates the reflectance of radiation at an incident angle of approximately 38 degrees, and a third curve 110 illustrates the reflectance of radiation at an incident angle of approximately 50 degrees. As illustrated by graph 100, a reflective bandwidth 112 at each of the three illustrated angles of incidence (i.e. 20, 38, and 50-degrees) is approximately equal to the bandwidth of the visible portion of the electromagnetic spectrum (approximately 400-750 nm).

As such, by gradually increasing the thickness of each of the alternating layers of optical coating 62 from generally the first end 64 to the second end 66 of reflector 42, the reflective bandwidth for all angles of incidence within a desired range of incident angles are substantially equal to the visible portion of the electromagnetic spectrum. In one embodiment, for example, the desired range of incident angles is from approximately 10-degrees to approximately 50-degrees.

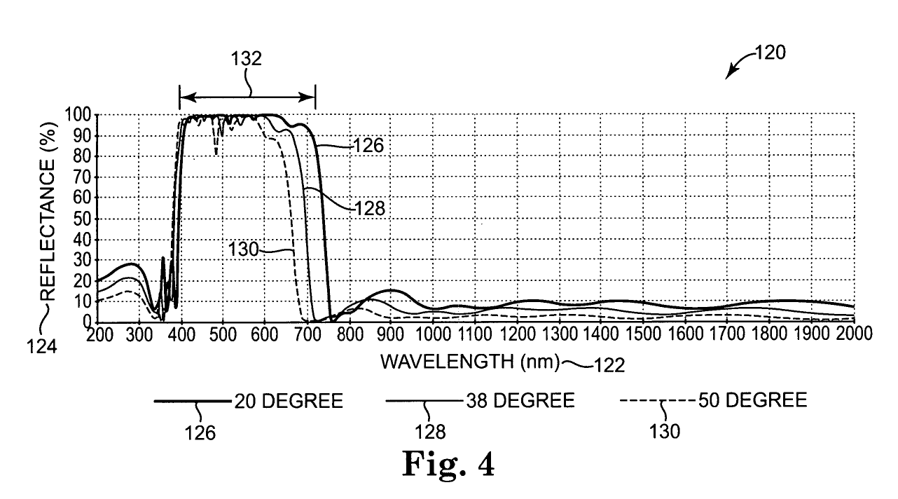

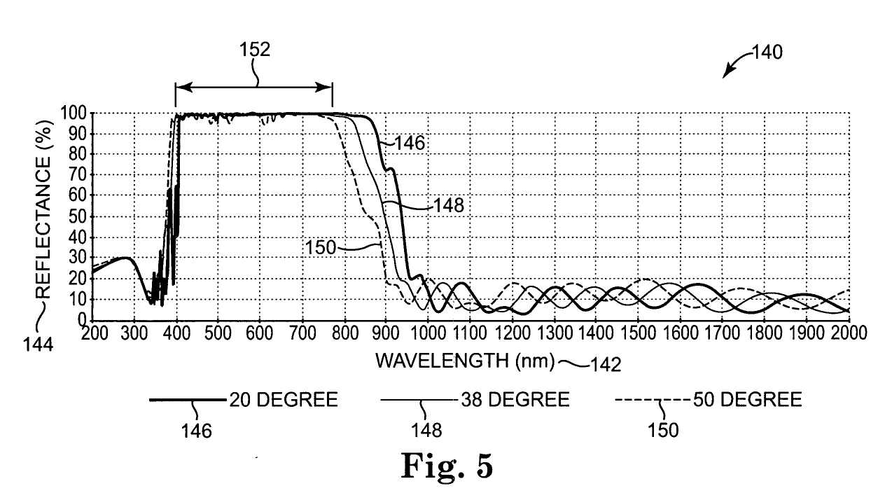

For comparison, FIGS. 4 and 5 illustrate the reflectance performance of a reflector when an optical coating is implemented based on conventional techniques in lieu of wedge-coating techniques in accordance with the present invention. FIG. 4 is a graph 120 illustrating the reflective performance of a reflector having an optical coating similar to that described by Table I, except that each of the alternating layers has a uniform thickness and does not increase from a closed first end to an open second end. The wavelength of incident radiation from a light source is illustrated along the x-axis, as indicated at 122, and the reflectance of the reflector (in percent) is illustrated along the y-axis, as indicated at 124. A first curve 126 illustrates the reflectance of radiation at an incident angle of approximately 20 degrees, a second curve 128 illustrates the reflectance of radiation at an incident angle of approximately 38 degrees, and a third curve 130 illustrates the reflectance of radiation at an incident angle of approximately 50 degrees.

As illustrated by graph 120, while curve 126 corresponding to radiation at an incident angle of 20-dgrees has a reflective bandwidth 132 which is approximately equal to the bandwidth of the visible light, the reflective bandwidth decreases with increasing angle of incidence. In this implementation, the reflective bandwidth for radiation at an incident angle of 38-degrees ranges from approximately 400 nm to only 690 nm, while the reflective bandwidth for radiation at an incident angle of 50-degrees ranges from approximately 400 nm to only 650 nm, both of which are less than the bandwidth of visible light. As illustrated by graph 120, the reflective bandwidth decreases as the angle of incidence of the radiation increases, resulting in unequal color reflectance and a loss of brightness in a projected image.

FIG. 5 is a graph 140 illustrating the reflective performance of a reflector having an optical coating similar to the optical coating of the reflector whose performance is illustrated by graph 120 of FIG. 4, except that a number of alternating layers has been increased from 25 layers to 38 layers. As with the implementation described with respect to FIG. 4, each of the alternating layers has a uniform thickness and does not increase from a closed first end to an open second end 66. The wavelength of incident radiation from a source is illustrated along the x-axis, as indicated at 142, and the reflectance of the reflector (in percent) is illustrated along the y-axis, as indicated at 144. A first curve 146 illustrates the reflectance of radiation at an incident angle of approximately 20 degrees, a second curve 148 illustrates the reflectance of radiation at an incident angle of approximately 38 degrees, and a third curve 150 illustrates the reflectance of radiation at an incident angle of approximately 50 degrees.

As illustrated by curve 150, relative to the reflector whose performance is illustrated by FIG. 4, a reflective bandwidth 152 of radiation at an incident angle of 50-degrees is increased so as to be near 100 percent reflectance for approximately the bandwidth of the visible portion of the electromagnetic spectrum (i.e. 450-750 nm). However, as illustrated by respective curves 146 and 148, the reflective bandwidths of radiation at incident angles of 20 and 38 degrees are extended so as to be well beyond the visible portion of the electromagnetic spectrum and into the IR portion of the spectrum (i.e. beyond 750 nm). At an incident angle of 20 degrees, for example, the reflective bandwidth is approximately from 400 nm to 900 nm, and at an incident angle of 38 degrees the reflective bandwidth is approximately from 400 nm to 850 nm. As illustrated by graph 140, the reflective bandwidth generally increases toward the longer wavelengths as the angle of incidence of the radiation decreases. Thus, although the equalization of reflected color is improved, an increased amount of potentially damaging IR radiation is transmitted to other components of projector 30.

Although described and illustrated herein as being generally semi-elliptical in shape, reflector 42 can be of other flat or curved shapes (e.g. parabolic) and the teachings of the present invention can be applied to any reflector shape where the angle of incident radiation is changing across the reflector's surface. Also, although described primarily in terms TiO₂ and SiO₂, optical coating 62 may comprise any suitable combination of high and low refractive index dielectric materials. Examples of other suitable high refractive index dielectric materials include tantalum oxide (TaOx), niobium oxide (NbOx), zirconium oxide (ZrOx), and hafnium oxide (HfOx). Examples of other suitable low refractive index dielectric materials include magnesium fluoride (MgF2), calcium fluoride (CaF₂), cryolite (Na₃AIF₆), and aluminum oxide (Al₂O₃). Furthermore, although described herein with regard to two materials, optical coating 62 may comprise layers of more than two materials of differing refractive indices.

Also, in addition to a glass substrate (e.g. BK-7), other types of substrates can be employed, including metallic substrates. Additionally, although described as optimizing reflectance in the visible portion of the electromagnetic spectrum (i.e. 400 nm-750 nm), the teachings of the present invention can be employed to optimize reflectance of optical coating 62 over other desired bandwidths. Furthermore, although described with respect to a projector, the teaching of the present invention can be applied to reflectors configured for use in any number of devices, such as heat lamps and surgical lamps, for example.

Although specific embodiments have been illustrated and described herein for purposes of description of the preferred embodiment, it will be appreciated by those of ordinary skill in the art that a wide variety of alternate and/or equivalent implementations may be substituted for the specific embodiments shown and described without departing from the scope of the present invention. Those with skill in the mechanical, electro-mechanical, electrical, and computer arts will readily appreciate that the present invention may be implemented in a very wide variety of embodiments. This application is intended to cover any adaptations or variations of the preferred embodiments discussed herein. Therefore, it is manifestly intended that this invention be limited only by the claims and the equivalents thereof.

What is claimed is:

1. A reflector, comprising:
a substrate having a first end and a second end; and
an optical coating of at least first and second materials having differing refractive indices deposited on the substrate, the optical coating comprising a plurality of alternating layers of the first and second materials with each layer having a thickness which increases from the first end to the second end of the substrate.

2. The reflector of claim 1, wherein the optical coating is adapted to receive electromagnetic radiation having an angle of incidence that increases over a range of incident angles from the first end to the second end of the substrate, and wherein the optical coating is adapted to reflect the electromagnetic radiation such that a reflective bandwidth for electromagnetic radiation at each incident angle within the range of incident angles is substantially equal to a desired reflective bandwidth.

3. The reflector of claim 2, wherein the range of incident angles is between approximately zero degrees and approximately fifty degrees.

4. The reflector of claim 2, wherein the desired reflective bandwidth is substantially equal to a bandwidth of a visible portion of the electromagnetic spectrum.

5. The reflector of claim 1, wherein the thickness of each layer at the second end is within a thickness range that is between approximately ten percent and twenty percent greater than the thickness at the first end.

6. The reflector of claim 2, wherein the thickness of each layer increases from the first end to the second end based on the angle of incidence of the electromagnetic radiation.

7. The reflector of claim 6, wherein the thickness of each layer increases substantially linearly from the first end to the second end of the substrate.

8. The reflector of claim 6, wherein the thickness of each layer increases non-linearly from the first end to the second end of the substrate.

9. The reflector of claim 1, wherein the first and second materials comprise dielectric materials with the first material having a refractive index different than a refractive index of the second material.

10. The reflector of claim 1, wherein the first material includes one of titanium dioxide (TiO₂), tantalum oxide (TaOx), niobium oxide (NbOx), zirconium oxide (ZrOx), and hafnium oxide (HfOx).

11. The reflector of claim 1, wherein the second material includes one of silicon dioxide (SiO₂), magnesium fluoride (MgF₂), calcium fluoride (CaF₂), cryolite (Na₃AIF₆), and aluminum oxide (Al₂O₃).

12. The reflector of claim 1, wherein the reflector is curved with the first end comprising a substantially closed end and the second end comprising a substantially open end.

13. The reflector of claim 1, wherein the substrate comprises glass.

14. The reflector of claim 1, wherein the substrate comprises a metal.

15. A device including the reflector of claim 1.

16. A light source, comprising:
a lamp configured to generate electromagnetic radiation; and
a reflector including a substrate having a first end and a second end, and an optical coating of at least first and second materials having differing refractive indices deposited on the substrate,
wherein the optical coating comprises a plurality of alternating layers of the first and second materials with each of the layers having a thickness which increases from the first end to the second end of the substrate, and
wherein the reflector is positioned relative to the lamp such that an angle of incidence of electromagnetic radiation upon the optical coating increases over a range of incident angles from the first end to the second end of the substrate.

17. The light source of claim 16, wherein the optical coating is adapted to reflect the electromagnetic radiation such that a reflective bandwidth of electromagnetic radiation at each incident angle within the range of incident angles is substantially equal to a bandwidth of a visible portion of the electromagnetic spectrum.

18. The light source of claim 17, wherein the range of incident angles is between approximately zero degrees and approximately fifty degrees.

19. The light source of claim 16, wherein the substrate is curved with a closed end forming the first end and an open end forming the second end.

20. The light source of claim 16, wherein the thickness of each layer at the second end is within a thickness range that is between approximately ten percent and twenty percent greater than the thickness at the first end.

21. The light source of claim 16, wherein the first and second materials comprise dielectric materials with the first material having a refractive index different than a refractive index of the second material.

22. A method of making a reflector configured to receive incident electromagnetic radiation over a range of incident angles increasing from a first end to a second end of the reflector, the method comprising:
providing a substrate material;
depositing on the substrate a plurality of alternating layers of at least first and second dielectric materials having differing refractive indices, including increasing a thickness of each layer from the first end to the second end of the reflector.

23. The method of claim 22, wherein depositing the alternating layers includes providing a number of alternating layers such that a reflective bandwidth of the reflector for electromagnetic radiation at each incident angle within the range of incident angles is substantially equal to a desired reflective bandwidth.

24. The method of claim 23, wherein the desired reflective bandwidth is substantially equal to a visible portion of the electromagnetic spectrum.

25. The method of claim 22, wherein depositing the alternating layers includes linearly increasing the thickness of each of the alternating layers from the first end to the second end of the reflector.

26. The method of claim 22, wherein the thickness of each layer proximate to the second end of the reflector is from approximately ten percent to approximately twenty percent greater than the thickness of each layer proximate to the first end of the reflector.

27. The method of claim 22, wherein depositing the alternating layers includes increasing the thickness of each of the alternating layers from the first end to the second end of the reflector as a function of the incident angle of electromagnetic radiation.

28. The method of claim 22, wherein providing the substrate material includes providing the substrate material with a curved shape, with the first end of the reflector being proximate to a closed end of the substrate and the second end of the reflector being proximate to an open end of the substrate.

29. A reflector, comprising:
a substrate having a first end and a second end;
means for receiving incident electromagnetic radiation over a range of incident angles increasing from the first end to the second end of the substrate; and
means for reflecting the incident electromagnetic radiation such that a reflective bandwidth of electromagnetic radiation at each incident angle within the range of incident angles is substantially equal to a desired reflective bandwidth.

30. The reflector of claim 29, wherein the desired reflective bandwidth is substantially equal to a visible portion of the electromagnetic spectrum.

31. A reflector, comprising:
a substrate; and
an optical coating of twenty-five or fewer alternating layers of first and second dielectric materials deposited on the substrate,
wherein a reflective bandwidth of the reflector is maintained substantially uniform for electromagnetic radiation having angles of incidence between approximately zero degrees and approximately fifty degrees.
